(19) United States
(12) Patent Application Publication
(10) Pub. No.: US 2009/0252409 A1
(43) Pub. Date: Oct. 8, 2009

(54) IMAGE FORMING APPARATUS, IMAGE PROCESSING APPARATUS AND IMAGE PROCESSING METHOD

(75) Inventor: Seiji Saito, Izunokuni-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/062,020

(22) Filed: Apr. 3, 2008

(51) Int. Cl. G06K 9/00

(52) U.S. Cl. 382/167

(57) ABSTRACT

An image forming apparatus of the invention includes a CPU, a RAM, a ROM, a HDD, a network connection unit, an operation panel, a JOB execution unit, a surrounding color correction coefficient storage unit, an area correction function storage unit and a database. The CPU functions as an image processing unit (image processing apparatus) by an image processing program. The image processing unit includes a noted color extraction unit, an area calculation unit, an area correction coefficient calculation unit, and a color correction unit. The area calculation unit calculates an area of the noted color region. The area correction coefficient calculation unit calculates an area correction coefficient based on a function stored in the area correction function storage unit, the area of the noted color region and the like. Based on the area correction coefficient received from the area correction coefficient calculation unit, the color correction unit corrects a skin color of image data to a skin color taking the area into consideration.

### BACKGROUND OF THE INVENTION

1. Technical Field of the Invention

The present invention relates to an image forming apparatus, an image processing apparatus, and an image processing method for performing an image processing on image data including a person.

2. Related Art

In an image including a person, one of most noticeable colors by a user is a skin color (skin tone). The user tends to be nervous about whether the skin color of especially a face region is a desired color.

When the skin color of image data is corrected, it is necessary to consider the influence of a color (hereinafter referred to as a surrounding color) of an image existing around the skin color region to be corrected. This is because even if a color is perceived to be a desired skin color in the case where attention is paid to one pixel, there is a case where the user does not perceive (recognize) the color to be the desired color by the influence of the surrounding color.

Hitherto, various techniques have been proposed in order to perform the correction of the skin color of the image data taking the surrounding color into consideration.

For example, an image processing apparatus disclosed in JP-A 2000-242775 includes face region extraction means for extracting a face region of a person from an image and adjustment means for adjusting the density and color of the face region based on the density information and color information of the periphery of the face region. The image processing apparatus can adjust the color density of the face region based on the extracted color density of the periphery of the face region, and can correct the face region so that it is perceived to have a proper color density without being influenced by the color density of the periphery of the face.

Besides, in an image processing apparatus disclosed in JP-A 2004-192614, when the skin color of a face region is corrected based on the density and color of a surrounding color, an occupied area of the face region in image data is taken into consideration, so that in the case where the image data is a desired skin color, correction is not performed more than necessary.

Incidentally, in the human visual characteristics, there is a characteristic that the identical colors are perceived to be different colors only if the sizes of the areas are different from each other. Even if there is no color difference between colors in the case where attention is paid to one pixel, as the area becomes large, the user feels that the color is more vivid and brighter.

Thus, when printing is performed without taking the area of each color into consideration, the user feels that a wide region is bright, and a narrow region is dark. Thus, the user feels that for example, a face close to a camera is bright and vivid, and a remote face is a dark face.

Besides, when printing or the like is performed, there is a case where the user performs the enlargement or contraction of an image. When the image is enlarged or contracted, the area of a noted region, such as a face region, is changed. Thus, when the printing accompanying the enlargement and contraction is performed, there is a case where the user feels that the color of the pixel becomes different from that before the enlargement or contraction is performed.

However, in the related art, this kind of human visual characteristics are not considered at all. Thus, in the related art, in the case where the area of the outputted noted pixel is changed, color correction taking the visual characteristics into consideration can not be performed.

### SUMMARY OF THE INVENTION

The present invention has been made in view of the above circumstances, and it is an object to provide an image forming apparatus, an image processing apparatus and an image processing method in which a noted color can be corrected according to the area of a noted color region in image data.

In order to achieve the above object, according to an aspect of the invention, an image processing apparatus includes a noted color extraction unit configured to extract a region of a noted color from image data, a database in which, with respect to the noted color, an area and an optimum color associated with the area are stored; an area calculation unit configured to calculate an area of the region of the noted color, an area correction coefficient calculation unit configured to calculate an area correction coefficient for obtaining the optimum color in the area of the noted color region based on the area of the noted color region and the area value stored in the database, and a color correction unit configured to correct the noted color of the image data based on the area correction coefficient.

Besides, in order to achieve the above object, according to another aspect of the invention, an image forming apparatus includes an image processing unit, and an image formation unit configured to print image data, color of which has been corrected by the image processing unit, on a recording sheet, and the image processing unit includes a noted color extraction unit configured to extract a region of a noted color from the image data, a database in which, with respect to the noted color, an area and an optimum color associated with the area are stored; an area calculation unit configured to calculate an area of the region of the noted color, an area correction coefficient calculation unit configured to calculate an area correction coefficient for obtaining the optimum color in the area of the noted color region based on the area of the noted color region and the area value stored in the database, and a color correction unit configured to correct the noted color of the image data based on the area correction coefficient.

Besides, in order to achieve the above object, according to another aspect of the invention, an image processing method includes extracting a region of a noted color from image data, storing, with respect to the noted color, an area and an optimum color associated with the area are stored; calculating an area of the region of the noted color, calculating an area correction coefficient for obtaining the optimum color in the area of the noted color region based on the area of the noted color region and the area value stored in the database, and correcting the noted color of the image data based on the area correction coefficient.

### BRIEF DESCRIPTION OF THE DRAWINGS

In the accompanying drawings:

FIG. 1 is a view showing a structural example of an image forming apparatus according to a first embodiment of the invention;

FIG. 2 is an explanatory view showing an example of a function stored in an area correction coefficient storage unit;

FIG. 3 is a schematic block diagram showing a structural example of a function realizing unit realized by a CPU according to the first embodiment;

FIG. 4 is a flowchart showing a procedure at the time when a noted color is corrected according to an area of a noted color region in image data by the CPU of the image forming apparatus according to the first embodiment;

FIG. 5 is a schematic block diagram showing a structural example of a function realizing unit realized by a CPU according to a second embodiment; and

FIG. 6 is a flowchart showing a procedure at the time when a noted color is corrected according to an area of a noted color region in image data by the CPU of the image forming apparatus according to the second embodiment.

### DETAILED DESCRIPTION

Embodiments of an image forming apparatus, an image processing apparatus and an image processing method of the invention will be described with reference to the accompanying drawings.

### (1) First Embodiment

### (1-1) Structure

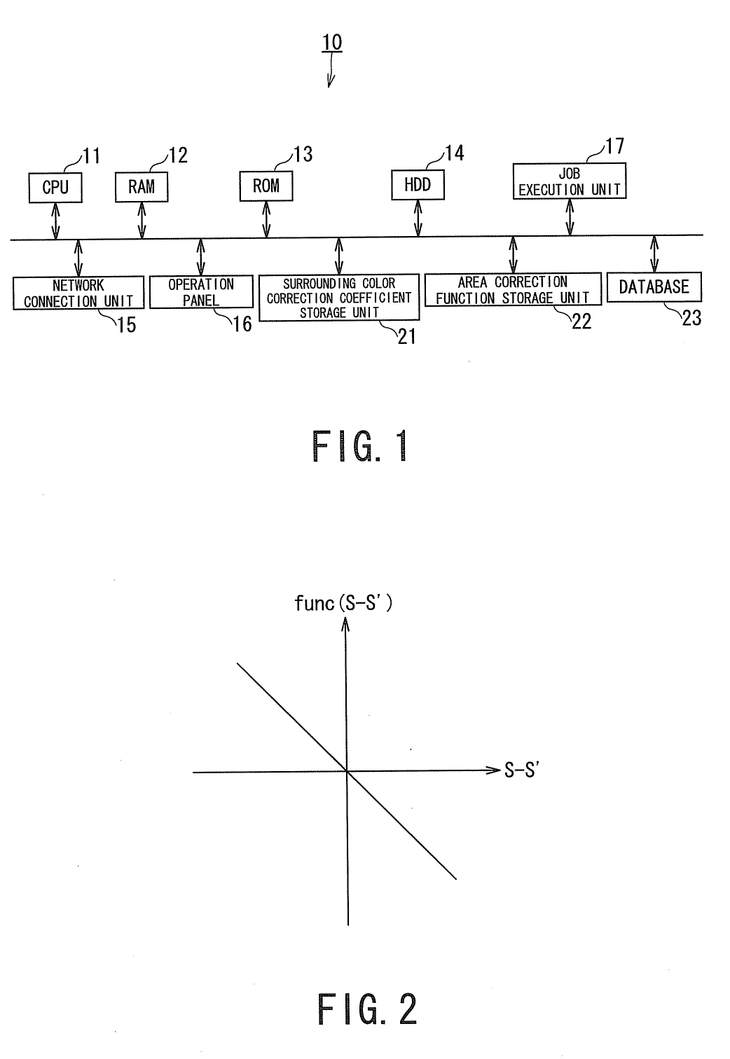

FIG. 1 is a view showing a structural example of an image forming apparatus 10 according to a first embodiment.

In the following description, there is described an example of a case where a multi function peripheral having a copy function, a printer function, a scanner function and the like is used as the image forming apparatus 10. Besides, in the following description, there is described an example of a case where a color to be corrected (i.e. a noted color) of image data is a skin color.

The image forming apparatus 10 includes a CPU 11, a RAM 12, a ROM 13, a hard disk drive (HDD) 14, a network connection unit 15, an operation panel 16, a JOB execution unit 17, a surrounding color correction coefficient storage unit 21, an area correction function storage unit 22 and a database 23.

The CPU 11 controls the operation of the image forming apparatus 10 in accordance with a program stored in the ROM 13. The CPU 11 loads the image processing program stored in the ROM 13 and data necessary for execution of the program to the RAM 12. The CPU 11 controls the image forming apparatus 10 in accordance with the image processing program, and executes a color correction processing taking a surrounding color into consideration and a color correction processing taking an area of a noted color into consideration.

The RAM 12 provides a work area for temporarily storing the program executed by the CPU 11 and the data.

The ROM 13 stores a boot program of the image forming apparatus 10, an image processing program, and various data necessary for execution of these programs.

The ROM 13 may have a structure including a recording medium readable by the CPU 11, such as a magnetic or optical recording medium or a semiconductor memory, and may be structured such that part or all of the programs and the data in the ROM 13 are downloaded through an electronic network.

The HDD 14 stores image data subjected to image processing by the CPU 11, image data read by the JOB execution unit 17, and the like.

Various information communication protocols according to a form of a network are implemented in the network connection unit 15. The network connection unit 15 connects the image forming apparatus 10 with other electronic equipments in accordance with the various protocols. Electrical connection through the electronic network can be applied to this connection. Here, the electronic network means a general information communication network using an electric communication technique, and includes a telephone communication line network, an optical fiber communication network, a cable communication network, a satellite communication network and the like in addition to a LAN (Local Area Network) and the Internet.

The operation panel 16 includes hard keys, such as buttons, to respectively give intrinsic instruction signals to the CPU 11 when the operator depresses them, and a display input unit. The operation panel 16 receives at least setting relating to enlargement and contraction of image data.

The display input unit includes an LCD as a display unit, and a touch panel provided in the vicinity of the LCD. The LCD is controlled by the CPU 11, and displays information for operating the image forming apparatus 10 and plural keys (hereinafter referred to as soft keys) for operating the image forming apparatus 10. The touch panel gives information of an instruction position on the touchpanel by the operator to the CPU 11 of the image forming apparatus 10.

The JOB execution unit 17 realizes various functions, such as the copy function, the printer function, the facsimile function, and the scanner function, of the image forming apparatus 10.

The surrounding color correction coefficient storage unit 21 stores information for determining a surrounding color correction coefficient. The surrounding color correction coefficient is associated with a memory color and a surrounding color. The CPU 11 acquires the surrounding color correction coefficient from the surrounding color correction coefficient storage unit 21 based on information of the memory color and the surrounding color.

The area correction function storage unit 22 stores a function used by the CPU 11 when an area correction coefficient is calculated. FIG. 2 is an explanatory view showing an example of the function stored in the area correction function storage unit 22. Although FIG. 2 shows a linear function as an example of the function, this function may be a non-linear function such as a sigmoid function or may be a table, not a function.

The database 23 stores information of memory colors including a skin color and preferred colors corresponding to the memory colors. Besides, with respect to each of the memory colors, the database 23 stores an area and an optimum color associated with the area. In the following description, the area stored in the database 23 is denoted by “area S′”.

Here, the memory colors are colors memorized by a person in relation to specific things, and are, for example, a color of skin, a color of sky, a color of sea, a color of vegetation, a color of snow and the like. From many experiences, the person memorizes the characteristic property of the thing with emphasis. In general, there is a tendency that the memory color is memorized such that as compared with the original thing, a bright color is brighter, a dark color is darker, and a vivid color is more vivid.

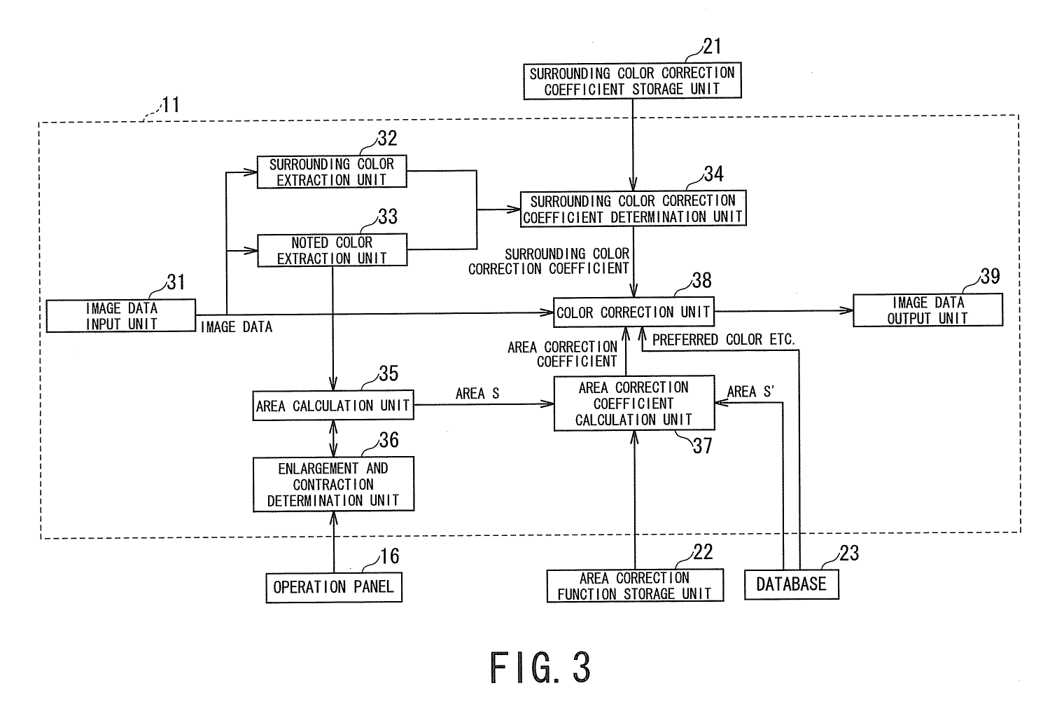

FIG. 3 is a schematic block diagram showing a structural example of function realizing units realized by the CPU 11 according to the first embodiment. Each of the function realizing units may be constructed by a hardware logic circuit or the like without using the CPU 11.

The CPU 11 functions as an image processing unit (image processing apparatus) by the image processing program. The image processing unit (image processing apparatus) uses a specified work area of the RAM 12 as a temporal storage place of data.

The image processing unit includes an image data input unit 31, a surrounding color extraction unit 32, a noted color extraction unit 33, a surrounding color correction coefficient determination unit 34, an area calculation unit 35, an enlargement and contraction determination unit 36, an area correction coefficient calculation unit 37, a color correction unit 38 and an image data output unit 39.

The image data input unit 31 receives input of image data as an object on which an image processing is performed. The image data may be inputted from the outside of the image processing apparatus through the network connection unit 15, or may be one stored in the HDD 14 of the image processing apparatus.

The surrounding color extraction unit 32 extracts a color (surrounding color) in the periphery of a skin color as the noted color and a region of the surrounding color from the image data received from the image data input unit 31. Hitherto, various methods are known as methods of extracting the surrounding color, and an arbitrary one of these can be used. This kind of methods include, for example, a method using clustering (see, for example, JP-A 2004-192614) and a method of extraction by expanding the noted color region to the outside (see, for example, JP-A 2000-242775).

The noted color extraction unit 33 extracts the skin color as the noted color and the region of the skin color from the image data received from the image data input unit 31. Hitherto, various methods are known as methods of extracting the skin color, and an arbitrary one of these can be used. This kind of methods include, for example, a method using color clustering (see, for example, Rein-Lien Hsu, Abdel-Mottaleb, Anil K. Jain, “Face Detection in Color Images,” IEEE TRANS. PAMI, VOL. 24 NO. 5 PP. 696-706, 2002), a method of NN, SVM, Adaboost or the like using learning (see, for example, Paul Viola, Michael Jones, “Robust Real-time Object Detection,”) and a method using face extraction.

The surrounding color correction coefficient determination unit 34 receives information of the surrounding color from the surrounding color extraction unit 32 and information of the skin color from the noted color extraction unit 33. Besides, the surrounding color correction coefficient determination unit 34 acquires a surrounding color correction coefficient associated with the skin color and the surrounding color from the surrounding color correction coefficient storage unit 21, and gives it to the color correction unit 38.

Incidentally, in the case where the memory color and the surrounding color stored in the surrounding color correction coefficient storage unit 21 are inconsistent with the skin color and the surrounding color extracted from the image data, the surrounding color correction coefficient determination unit 34 may determine the surrounding color correction coefficient by a method of performing interpolation using plural correction coefficients, a method of singly using it to a close color, or a method of obtaining it by calculation (see, for example, JP-A 2000-242775 and JP-A 2004-192614).

The area calculation unit 35 calculates the area of the skin color region based on the information of the skin color region received from the noted color extraction unit 33. Hitherto, various methods are known as methods of calculating the area of the noted color region, and an arbitrary one of these can be used. For example, the area of the noted color region can be obtained by a method of performing clustering (see JP-A 2000-242775).

Besides, when receiving information indicating that the image data is to be enlarged or contracted from the enlargement and contraction determination unit 36, the area calculation unit 35 calculates the area after the enlargement or contraction. The area after the enlargement or contraction can be calculated from the resolution, the number of pixels and the enlargement or contraction ratio. In the following description, the area outputted from the area calculation unit 35 is denoted by “area S”.

The enlargement and contraction determination unit 36 determines whether an instruction to enlarge or contract the image data is issued from the user through the operation panel 16.

The area correction coefficient calculation unit 37 receives the area S of the skin color region from the area calculation unit 35 and the area S′ from the database 23. Then, the area correction coefficient calculation unit 37 calculates the area correction coefficient based on the function stored in the area correction function storage unit 22, the area S, and the area S′.

For example, in the case where the Lab (“L”, “a”, and “b”) color system is used, a correction amount HL of “L”, a correction amount Ha of “a” and a correction amount Hb of “b” are written as follows:

HL=func(S-S′)

### Ha=cos θ

### Hb=sin θ.

Here, func(S-S′) is the function stored in the area correction function storage unit 22 (see, for example, FIG. 2). Besides, θ is a hue angle (angle between “a” and “b” in the chromaticity diagram (“a”-“b” space)).

The color correction unit 38 corrects the skin color of the image data to the preferred color based on the information of the preferred color to the skin color received from the database 23. Besides, based on the surrounding color correction coefficient received from the surrounding color correction coefficient determination unit 34, the color correction unit 38 corrects the skin color to the preferred skin color taking the surrounding color into consideration. Further, based on the area correction coefficient (for example, LH, La, Lb) received from the area correction coefficient calculation unit 37, the color correction unit 38 corrects the skin color of the image data to the skin color taking the area into consideration. Incidentally, whichever of the color correction taking the surrounding color into consideration and the color correction taking the area into consideration may be performed first.

The image data output unit 39 receives the color corrected image data from the color correction unit 38, outputs the image data after the color correction to the JOB execution unit 17 and causes it to be printed on a recording sheet, or causes it to be stored in the HDD 14. Of course, the image data output unit 39 may output the image data after the color correction to the outside through the network connection unit 15.

### (1-2) Operation

An example of the operation (including the operation of the image processing unit) of the image forming apparatus 10 of this embodiment will be described.

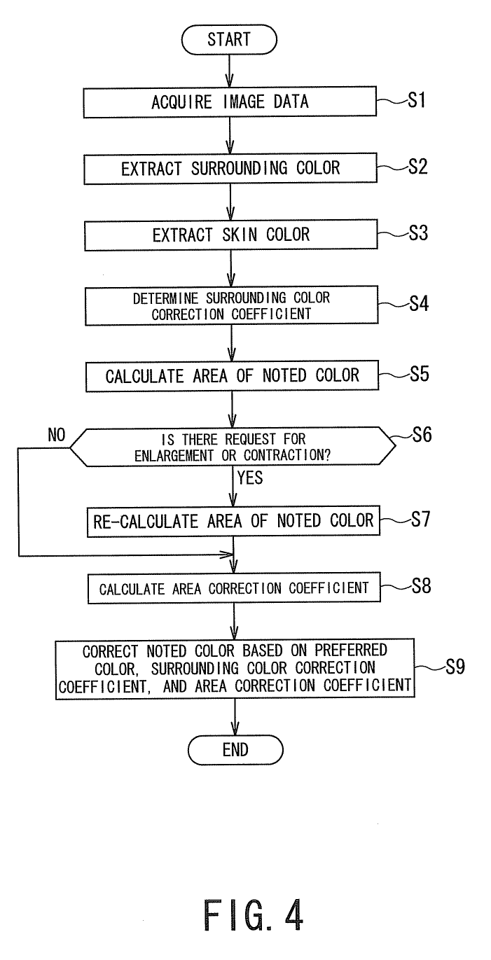

FIG. 4 is a flowchart showing a procedure at the time when a noted color is corrected according to the area of the noted color region in image data by the CPU 11 of the image forming apparatus 10 shown in FIG. 1. In FIG. 4, a symbol including S and a numeral attached thereto denotes each step in the flowchart. Incidentally, information indicating that the noted color is the skin color is given to the image processing unit in advance.

First, at step S1, the image data input unit 31 receives the input of image data as an object on which the image processing is to be performed.

At step S2, the surrounding color extraction unit 32 extracts a color (surrounding color) in the periphery of the skin color as the noted color and the region of the surrounding color from the image data received from the image data input unit 31.

At step S3, the noted color extraction unit 33 extracts the skin color as the noted color and the region of the skin color from the image data received from the image data input unit 31.

At step S4, the surrounding color correction coefficient determination unit 34 determines a surrounding color correction coefficient based on information of the surrounding color received from the surrounding color extraction unit 32, information of the skin color received from the noted color extraction unit 33 and information stored in the surrounding color correction coefficient storage unit 21, and gives the surrounding color correction coefficient to the color correction unit 38.

At step S5, the area calculation unit 35 calculates the area of the skin color region based on the information of the skin color region received from the noted color extraction unit 33.

At step S6, the enlargement and contraction determination unit 36 determines whether an instruction to enlarge or contract the image data is issued from the user through the operation panel 16. In the case where the instruction to enlarge or contract is issued, advance is made to step S7. On the other hand, in the case where the instruction to enlarge or contract is not issued, the calculated area S is given to the area correction coefficient calculation unit 37 and advance is made to step S8.

At step S7, the area calculation unit 35 receives the information indicating that the image data is to be enlarged or contracted from the enlargement and contraction determination unit 36, and calculates the area after the enlargement or contraction based on the resolution, the number of pixels and the enlargement or contraction ratio. Then, the area calculation unit 35 gives the calculated area S to the area correction coefficient calculation unit 37. The enlargement or contraction ratio may be given to the area calculation unit 35 from the operation panel 35.

At step S8, the area correction coefficient calculation unit 37 receives the area S of the skin color region from the area calculation unit 35 and the area S′ from the database 23. The area correction coefficient calculation unit 37 calculates the area correction coefficient based on the function stored in the area correction function storage unit 22, the area S and the area S′, and gives the area correction coefficient to the color correction unit 38.

At step S9, the color correction unit 38 acquires information of a preferred color to the skin color from the database 23, and corrects the skin color of the image data to the desirable color. Besides, based on the surrounding color correction coefficient received from the surrounding color correction coefficient determination unit 34, the color correction unit 38 corrects the desirable skin color to the desirable skin color taking the surrounding color into consideration. Further, based on the area correction coefficient received from the area correction coefficient calculation unit 37, the color correction unit 38 corrects the skin color of the image data to the skin color taking the area into consideration.

By the above procedure, the color correction process taking the surrounding color into consideration and the color correction process taking the area of the noted color into consideration can be performed.

The image forming apparatus 10 and the image processing apparatus of this embodiment can correct the noted color according to the area of the noted region in view of the human visual characteristics to the area of the image. Thus, according to the image forming apparatus 10 and the image processing apparatus of this embodiment, as compared with the related art, the noted color can be made the color more desired by the user.

Besides, the image forming apparatus 10 and the image processing apparatus of this embodiment are constructed to be capable of coping with the enlargement and contraction accompanying the area change of the image data. Thus, even in the case where the enlargement or contraction of the image is performed when printing or the like is performed, the color correction corresponding to the change of the area of the noted region can be performed to the noted color. Accordingly, the image forming apparatus 10 and the image processing apparatus of this embodiment are very convenient.

### (2) Second Embodiment

Next, a second embodiment of an image forming reproduction apparatus of the invention will be described.

An image forming apparatus 10A described in the second embodiment is different from the image forming apparatus 10 described in the first embodiment in that an image processing unit further includes an area ratio calculation unit 41 and a distance calculation unit 42, and in the function of a surrounding color correction coefficient determination unit 34. Since other constitutions and functions are not substantially different from those of the image forming apparatus 10 shown in FIG. 1, the same constitutions are denoted by the same reference numerals and their explanation will be omitted.

### (2-1) Structure

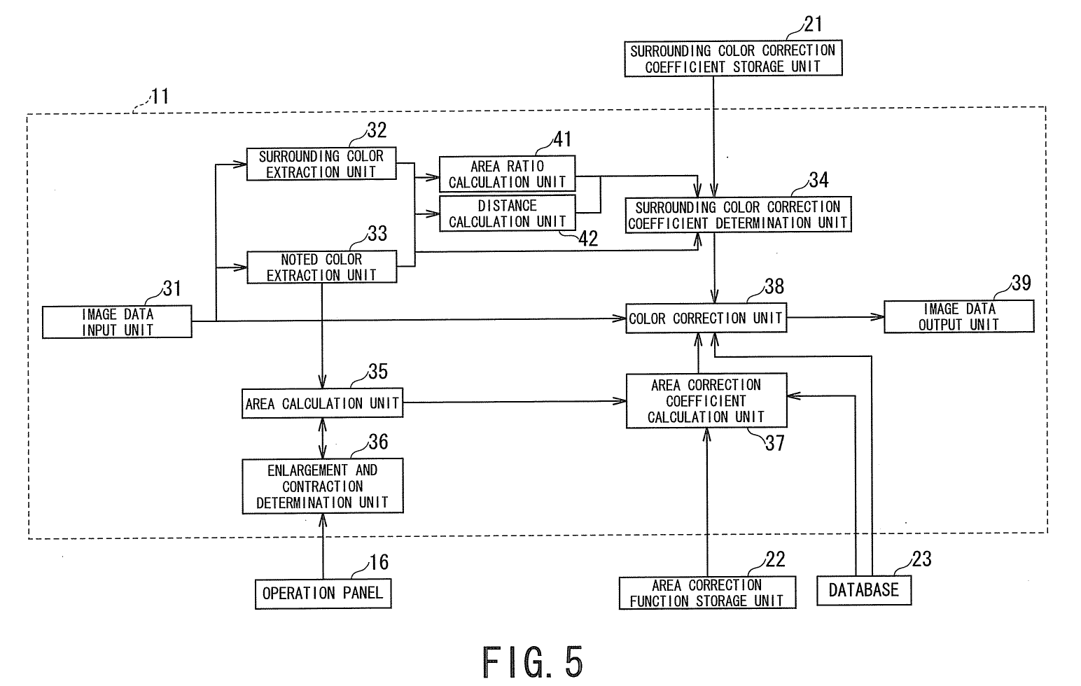

FIG. 5 is a schematic block diagram showing a structural example of a function realizing unit realized by a CPU 11 according to the second embodiment.

The area ratio calculation unit 41 receives information of a surrounding color region from a surrounding color extraction unit 32 and information of a skin color region from a noted color extraction unit 33, and calculates an area ratio between the surrounding color region and noted color region.

The distance calculation unit 42 receives the information of the surrounding color region from the surrounding color extraction unit 32 and the information of the skin color region from the noted color extraction unit 33, and calculates a distance between the surrounding color and the noted color.

The surrounding color correction coefficient determination unit 34 receives information of the surrounding color from the surrounding color extraction unit 32, information of the skin color from the noted color extraction unit 33, information of the area ratio between the surrounding color region and the noted color region from the area ratio calculation unit 41, and information of the distance between the surrounding color and the noted color from the distance calculation unit 42. Then, the surrounding color correction coefficient determination unit 34 acquires a surrounding color correction coefficient correlated to the skin color and the surrounding color from the surrounding color correction coefficient storage unit 21, and gives it to a color correction unit 38.

In this embodiment, when determining the surrounding color correction coefficient, the surrounding color correction coefficient determination unit 34 can use the information of the area ratio between the surrounding color region and the noted color region and the information of the distance between the surrounding color and the noted color.

As a method of determining the surrounding color correction coefficient by using the information, for example, there is a calculation method in which the influence of the peripheral pixel exerted on the surrounding color correction coefficient is assumed to be proportional linearly or non-linearly to the Euclidian distance between the noted pixel and the surrounding pixel, or a calculation method in which what is similar to a filter coefficient is used for the influence of the surrounding pixel exerted on the surrounding color correction coefficient. In the case where these calculation methods are used, in addition to the calculation at each pixel, it is appropriate that a typical point is provided in the surrounding color and the calculation is performed (see, for example, JP-A 2000-242775 and JP-A 2004-192614). Besides, a technique may be used in which the density is not unnaturally changed at the boundary region between the skin color and the surrounding color (see, for example, JPA 2000-242775).

### (2-2) Operation

Next, an example of the operation (including the operation of the image processing unit) of the image forming apparatus 10A of the second embodiment will be described.

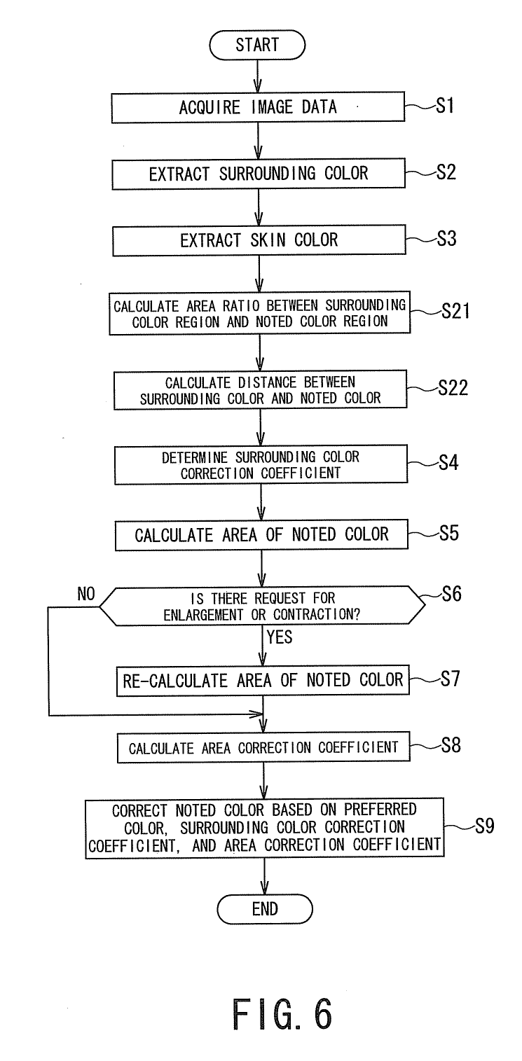

FIG. 6 is a flowchart showing a procedure at the time when a noted color is corrected according to the area of the noted color region in the image data by the CPU 11 of the image forming apparatus 10A of the second embodiment. An equivalent step to that of FIG. 4 is denoted by the same symbol and the duplicate explanation will be omitted.

At step S21, the area ratio calculation unit 41 receives information of the surrounding color region from the surrounding color extraction unit 32 and information of the skin color region from the noted color extraction unit 33, and calculates the area ratio between the surrounding color region and the noted color region.

At step S22, the distance calculation unit 42 receives the information of the surrounding color region from the surrounding color extraction unit 32 and the information of the skin color region from the noted color extraction unit 33, and calculates the distance between the surrounding color and the noted color.

When the color correction is performed, first, each pixel of the skin color may be converted according to the influence of brightness contrast by using the information of the area ratio between the skin color region and the surrounding color region, the distance between the respective pixels and the like.

Also according to the image forming apparatus 10A of this embodiment, the operation and effect similar to those of the image forming apparatus 10 of the first embodiment are obtained. Besides, according to the image forming apparatus 10A of the embodiment, since the information of the area ratio between the skin color region and the surrounding color region and the distance between the skin color pixel and the surrounding pixel can be used, the color correction taking the surrounding color into consideration can be more properly performed.

The present invention is not limited to the above embodiments as described above, and in an implementation phase, the invention can be embodied while modifying the components within the scope not departing from the gist thereof. Besides, various embodiments of the invention can be made by appropriate combinations of plural components disclosed in the embodiments. For example, some components may be deleted from all the components disclosed in the embodiment. Further, components of different embodiments may be appropriately combined.

Besides, in the embodiment, although the example of the process has been described in which the respective steps of the flowchart are performed in time series along the described order, the process may not necessarily be performed in time series, and may be performed in parallel or individually.

What is claimed is:

1. An image processing apparatus, comprising:
a noted color extraction unit configured to extract a region of a noted color from image data;
a database in which, with respect to the noted color, an area and an optimum color associated with the area are stored;
an area calculation unit configured to calculate an area of the region of the noted color;
an area correction coefficient calculation unit configured to calculate an area correction coefficient for obtaining the optimum color in the area of the noted color region based on the calculated area of the noted color region and the area stored in the database; and
a color correction unit configured to correct the noted color of the image data based on the area correction coefficient.

2. The image processing apparatus according to claim 1, wherein when an execution request for one of enlargement and contraction of the image data is made, the area calculation unit re-calculates the area of the noted color region according to the request, and
the area correction coefficient calculation unit calculates the area correction coefficient for obtaining the optimum color in the re-calculated area of the noted color region based on the re-calculated area of the noted color region and the area value stored in the database.

3. The image processing apparatus according to claim 1, further comprising an area correction function storage unit configured to store a function for calculating the area correction coefficient,
wherein the area correction coefficient calculation unit calculates the area correction coefficient by using the function stored in the area correction function storage unit.

4. The image processing apparatus according to claim 1, further comprising
a surrounding color extraction unit configured to extract a surrounding color of the noted color from the image data, and
a surrounding color correction coefficient determination unit configured to determine, based on the surrounding color and the noted color, a surrounding color correction coefficient for obtaining the optimum color of the noted color taking the surrounding color into consideration,
wherein the color correction unit corrects the noted color of the image data based on the surrounding color correction coefficient and the area correction coefficient.

5. The image processing apparatus according to claim 4, further comprising a surrounding color correction coefficient storage unit configured to store information for determining the surrounding color correction coefficient,
wherein the surrounding color correction coefficient determination unit determines the surrounding color correction coefficient based on the information stored in the surrounding color correction coefficient storage unit.

6. The image processing apparatus according to claim 4, further comprising
an area ratio calculation unit configured to calculate an area ratio between a region of the surrounding color and the region of the noted color, and
a distance calculation unit configured to calculate a distance between the surrounding color and the noted color,
wherein, based on the surrounding color, the noted color, the area ratio and the distance, the surrounding color correction coefficient determination unit determines the surrounding color correction coefficient for obtaining the optimum color of the noted color taking the surrounding color into consideration.

7. The image processing apparatus according to claim 4, wherein the database further stores a preferred color of the noted color, and
the color correction unit corrects the noted color of the image data based on the preferred color, the surrounding color correction coefficient, and the area correction coefficient.

8. An image forming apparatus comprising:
an image processing unit; and
an image formation unit configured to print image data, color of which has been corrected by the image processing unit, on a recording sheet,
wherein the image processing unit comprises:
a noted color extraction unit configured to extract a region of a noted color from the image data;
a database in which, with respect to the noted color, an area and an optimum color associated with the area are stored;
an area calculation unit configured to calculate an area of the region of the noted color;
an area correction coefficient calculation unit configured to calculate an area correction coefficient for obtaining the optimum color in the area of the noted color region based on the calculated area of the noted color region and the area value stored in the database; and
a color correction unit configured to correct the noted color of the image data based on the area correction coefficient.

9. The image forming apparatus according to claim 8, wherein when an execution request for one of enlargement and contraction of the image data is made, the area calculation unit re-calculates the area of the noted color region according to the request, and
the area correction coefficient calculation unit calculates the area correction coefficient for obtaining the optimum color in the re-calculated area of the noted color region based on the re-calculated area of the noted color region and the area value stored in the database.

10. The image forming apparatus according to claim 8, further comprising an area correction function storage unit configured to store a function for calculating the area correction coefficient,
wherein the area correction coefficient calculation unit calculates the area correction coefficient by using the function stored in the area correction function storage unit.

11. The image forming apparatus according to claim 8, further comprising
a surrounding color extraction unit configured to extract a surrounding color of the noted color from the image data, and
a surrounding color correction coefficient determination unit configured to determine, based on the surrounding color and the noted color, a surrounding color correction coefficient for obtaining the optimum color of the noted color taking the surrounding color into consideration,
wherein the color correction unit corrects the noted color of the image data based on the surrounding color correction coefficient and the area correction coefficient.

12. The image forming apparatus according to claim 11, further comprising a surrounding color correction coefficient storage unit configured to store information for determining the surrounding color correction coefficient,
wherein the surrounding color correction coefficient determination unit determines the surrounding color correction coefficient based on the information stored in the surrounding color correction coefficient storage unit.

13. The image forming apparatus according to claim 11, further comprising
an area ratio calculation unit configured to calculate an area ratio between the region of the surrounding color and the region of the noted color, and
a distance calculation unit configured to calculate a distance between the surrounding color and the noted color,
wherein based on the surrounding color, the noted color, the area ratio and the distance, the surrounding color correction coefficient determination unit determines the surrounding color correction coefficient for obtaining the optimum color of the noted color taking the surrounding color into consideration.

14. The image forming apparatus according to claim 11, wherein the database further stores a preferred color of the noted color, and
the color correction unit corrects the noted color of the image data based on the preferred color, the surrounding color correction coefficient, and the area correction coefficient.

15. An image processing method, comprising:
extracting a region of a noted color from image data;
storing, with respect to the noted color, an area and an optimum color associated with the area are stored;
calculating an area of the region of the noted color;
calculating an area correction coefficient for obtaining the optimum color in the area of the noted color region based on the calculated area of the noted color region and the area stored in a database; and
correcting the noted color of the image data based on the area correction coefficient.

16. The image processing method according to claim 15, further comprising:
re-calculating the area of the noted color region when an execution request for one of enlargement and contraction of the image data is made;
wherein,
in the calculating the area correction coefficient, the area correction coefficient for obtaining the optimum color in the re-calculated area of the noted color region is calculated based on the re-calculated area of the noted color region and the area value stored in the database.

17. The image processing method according to claim 15, further comprising:
storing a function for calculating the area correction coefficient
wherein,
in the calculating the area correction coefficient, the area correction coefficient is calculated by using the function for calculating the area correction coefficient.

18. The image processing method according to claim 15, further comprising:
extracting a surrounding color of the noted color from the image data;
determining a surrounding color correction coefficient for obtaining the optimum color of the noted color taking the surrounding color into consideration, based on the surrounding color and the noted color,
wherein,
in the correcting the noted color of the image data, the noted color of the image data is corrected based on the surrounding color correction coefficient and the area correction coefficient.

19. The image processing method according to claim 18, further comprising:
storing information for determining the surrounding color correction coefficient,
wherein,
in the determining the surrounding color correction coefficient, the surrounding color correction coefficient is determined based on the information for determining the surrounding color correction coefficient.

20. The image processing method according to claim 18, further comprising:
calculating an area ratio between a region of the surrounding color and the region of the noted color;
calculating a distance between the surrounding color and the noted color,
wherein,
in the determining the surrounding color correction coefficient, the surrounding color correction coefficient for obtaining the optimum color of the noted color taking the surrounding color into consideration is determined based on the surrounding color, the noted color, the area ratio and the distance.
